(19) United States
(12) Patent Application Publication
(10) Pub. No.: US 2026/0106072 A1
(43) Pub. Date: Apr. 16, 2026

(54) POLYPHASE ROTARY TRANSFORMER FOR FIELD EXCITATION OF ELECTRIC MACHINES

(71) Applicant: UT-Battelle, LLC, Oak Ridge, TN (US)

(72) Inventors: Emrullah Aydin, Oak Ridge, TN (US); Omer C. Onar, Knoxville, TN (US); Burak Ozpineci, Knoxville, TN (US); Mostak Mohammad, Oak Ridge, TN (US)

(21) Appl. No.: 19/353,165

(22) Filed: Oct. 8, 2025

Related U.S. Application Data
(60) Provisional application No. 63/705,999, filed on Oct. 10, 2024.

(51) Int. Cl. H01F 38/18; H02K 11/00; H02K 11/33

(52) U.S. Cl. CPC H01F 38/18; H02K 11/0094; H02K 11/33

(57) ABSTRACT

A high frequency and high-speed polyphase rotary transformer construction for field excitation of WRSMs. A polyphase rotary transformer configuration may reduce the eddy current losses. Additional first and second metal rings that the rotary transformer includes further mitigate eddy currents with them being applicable to both single and polyphase rotary transformer designs. The first and second metal rings may include one or more of tapered surfaces, laminated ring configurations, surface depressions, and sectored constructions.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of wireless power transfer systems, also described as wireless energy transfer systems, and more particularly toward a rotary transformer capable of wireless power transfer, such as for use in electric motor applications where rotary transformer replaces brush/slipring based wound rotor synchronous motors (WRSM) also known as electrically excited synchronous motor (EESM) or separately excited synchronous motor (SESM).

### BACKGROUND

Wound rotor synchronous motors (WRSMs) are recognized candidates for use in electric vehicle (EV) traction systems, where permanent magnet motors (PMMs) are conventionally used. However, rare earth materials are expensive, resources are globally limited and subject to price volatility, and usually mining and recycling such materials are difficult tasks. Many automotive manufacturers are working on different solutions to use either less rare earth materials in PMMs, or use non-rare earth PMMs. Conventional WRSMs can control the field excitation, and can completely eliminate the use of rare earth materials. But conventional WRSMs have sliprings and brushes to transfer power from a stationary source to a rotating machine's rotor windings, which results in disadvantages, e.g., conventional WRSMs need frequent maintenance. Due to a short lifetime of brushes, contact wear can cause poor WRSM performance, potential overheating, and sparking. In addition, using sliprings and brushes add a new compartment to a conventional WRSM, which increases its size and reduces its power density. Conventional efforts have involved using a rotary transformer to energize rotor winding wirelessly to help eliminate these disadvantages of some conventional WRSMs.

One conventional WRSM configuration involves a magnetic coupler design that was demonstrated for a 4.35-kW rated power rotary transformer to minimize losses and reduce fringing fluxes. In this configuration, a fringing flux around the rotary transformer's air gap caused eddy current losses on the surrounding housing material such as aluminum and steel. This conventional system showed 58% efficiency without using a compensation system. Other different conventional coupler designs for a 20 W rotary transformer with 520 kHz switching frequency and 89% efficiency were achieved by using a series-series compensation. Yet another conventional design includes the stator and primary windings provided in an interleaved relationship, potentially reducing the leakage inductance, and yielding a 10-kW power application with efficiency of 95.9%.

In many conventional configurations, the rotating part has a ferrite material that can only be used for low-speed applications. For high-speed conventional rotating systems, the rotating parts are required to utilize smaller dimensions than the low-speed applications due to the mechanical stress. That is, using ferrite on the rotating part is a significant issue for conventional configurations at high speeds because the ferrites are brittle and rotation can result in vibration and additional mechanical stresses.

Conventionally, polyphase in wireless power transfer systems has enabled achieving higher power densities and smaller size magnetic couplers than single phase systems. These conventional systems have lower current ripples that can help reduce the DC bus capacitor size at the inverter input and rectifier output. However, there is limited research for three-phase rotary transformers and limited understanding of their physical attributes in WRSM or other applications.

### SUMMARY

In general, one innovative aspect of the subject matter described herein can be embodied in a three-phase rotary transformer may include a stator with a primary three-phase coil and a primary ferromagnetic-material core. The transformer may include a shaft configured to rotate relative to the stator during operation of the rotary transformer, and a holder including a pair of Al rings each affixed to the shaft and axially spaced from each other by a ring gap. The transformer may include a rotor with a support connected to the shaft through the ring gap to rotate the rotor along with the shaft. The rotor may include a secondary three-phase coil disposed on the support and spaced apart from the primary three-phase coil by a predetermined gap.

The foregoing and other embodiments can each optionally include one or more of the following features, alone or in combination. In particular, one embodiment includes all the following features in combination.

In some embodiments, the three-phase rotary transformer support may include a PCB.

In some embodiments, the three-phase coil and the secondary three-phase coil each may be implemented in either a unipolar three-phase coil or a bipolar three-phase coil.

In some embodiments, a wound rotor synchronous motor may include the three-phase rotary transformer according to one or more embodiments described herein. The motor may include an inverter and a resonant primary tuning network. The primary three-phase coil may be connected to the inverter through the resonant primary tuning network, such that currents through the primary three-phase coil may create a time varying rotational magnetic field captured by the secondary three-phase coil, so the time varying rotational magnetic field causes a high frequency voltage induced on the secondary three-phase coil. The motor may include a rectifier and rotor windings connected to the secondary three-phase coil through the rectifier.

In general, one innovative aspect of the subject matter described herein can be embodied in a rotary transformer that includes a stator with a primary coil and a primary ferromagnetic-material core. The rotary transformer may include a shaft configured to rotate relative to the stator during operation of the rotary transformer, and a holder with a pair of Al rings each affixed to the shaft and axially spaced from each other by a ring gap. The rotary transformer may include a rotor with a support connected to the shaft through the ring gap to rotate the rotor along with the shaft, and a secondary coil disposed on the support and spaced apart from the primary by a predetermined gap. The Al rings may be shaped and configured to reduce eddy currents induced therein during operation of the rotary transformer.

The foregoing and other embodiments can each optionally include one or more of the following features, alone or in combination. In particular, one embodiment includes all the following features in combination.

In some embodiments, the Al rings may be shaped and configured as rings with tapered edges.

In some embodiments, the Al rings may be shaped and configured as radially laminated rings.

In some embodiments, the Al rings may be shaped and configured as axially laminated rings.

In some embodiments, the Al rings may be shaped and configured as rings with periodic recessions on surfaces facing each other. The rings may be angularly shifted by one-half pitch.

In some embodiments, the Al rings may be shaped and configured as sectored rings having a pitch size within a predetermined pitch-size range.

In some embodiments, the sectored Al rings may have tapered edges.

In some embodiments, the primary coil and the secondary coil each may be a single-phase coil.

In some embodiments, the primary coil and the secondary coil each may be a three-phase coil.

In some embodiments, a wound rotor synchronous motor may include a rotary transformer according to one embodiment. The motor may include an inverter and a resonant primary tuning network. The primary coil may be connected to the inverter through the resonant primary tuning network, such that currents through the primary coil may create a time varying rotational magnetic field captured by the secondary coil, so the time varying rotational magnetic field causes a high frequency voltage induced on the secondary coil. The motor may include a rectifier and rotor windings connected to the secondary coil through the rectifier.

In some embodiments, an electric vehicle traction system may include the wound rotor synchronous motor according to one embodiment.

In general, one innovative aspect of the subject matter described herein can be embodied in a rotary transformer including a stator that with a primary transmitter and a primary core. The rotary transformer may include a shaft configured to rotate relative to the stator during operation of the rotary transformer. The rotary transformer may include first and second of metal rings axially spaced from each other by a ring gap.

The rotary transformer may include a rotor coupled to the shaft and operable to rotate along with the shaft. The rotor may include a support disposed at least partially within the ring gap between the first and second metal rings. The rotor may include a secondary receiver coupled to the support and spaced apart from the primary by a predetermined gap. The secondary receiver may be configured to rotate with the rotor along with the shaft, where the first and second metal rings may be shaped and configured to reduce eddy currents induced therein during operation of the rotary transformer.

The foregoing and other embodiments can each optionally include one or more of the following features, alone or in combination. In particular, one embodiment includes all the following features in combination.

In some embodiments, the support may include a PCB.

In some embodiments, the primary transmitter may include a primary three-phase coil and the secondary receiver includes a secondary three-phase coil.

In some embodiments, the primary three-phase coil and the secondary three-phase coil each may be implemented in either a unipolar secondary three-phase coil or a bipolar secondary three-phase coil.

In some embodiments, the primary transmitter and the secondary receiver each may be single-phase coils.

In some embodiments, a wound rotor synchronous motor may the rotary transformer according to one or more embodiments described herein. The motor may include an inverter and a resonant primary tuning network. The primary transmitter may be connected to the inverter through the resonant primary tuning network, such that currents through the primary transmitter may create a time varying rotational magnetic field captured by the secondary receiver, so the time varying rotational magnetic field causes a high frequency voltage induced on the secondary receiver. The motor may include a rectifier and rotor windings connected to the secondary receiver through the rectifier.

In some embodiments, the first metal ring may include a plurality of radially-laminated rings.

In some embodiments, the first metal ring may include a plurality of axially-laminated rings.

In some embodiments, the first and second metal rings each may include an inner surface and an outer surface spaced radially from the inner surface. The first and second metal rings each may include an upper surface and a lower surface that oppose each other. The ring gap may be defined between the lower surface of the first metal ring and the upper surface of the second metal ring.

In some embodiments, the lower surface of the first metal ring may include a first plurality of depressions, and the upper surface of the second metal ring may include a second plurality of depressions.

In some embodiments, first and second metal rings may be oriented relative to each about a common axis that is aligned with a central axis of the shaft. The lower surface of the first metal ring may rotated with respect to the upper surface of the second metal ring so that each of the first plurality of depressions is rotated between first and second depressions of the second plurality of depressions.

In some embodiments, the first and second metal rings may be sectored such that each of the first and second metal rings may include one or more notches formed along their respective outer surfaces.

In some embodiments, the one or more notches may extend radially inward from the outer surface and may be distributed at predetermined angular intervals about the circumference.

In some embodiments, the one or more notches may be rectangular, trapezoidal, or arcuate.

In some embodiments, first and second rings each may include an upper tapered surface between the outer surface and the upper surface and a lower tapered surface between the outer surface and the lower surface.

In general, one innovative aspect of the subject matter described herein can be embodied in a rotary transformer including a stator with a primary transmitter and a primary core. The stator may include a central axis, and the primary transmitter may include at least one primary side winding axis that is non-parallel to the central axis. The rotary transformer may include a shaft configured to rotate about the central axis relative to the stator during operation of the rotary transformer. The rotary transformer may include a rotor coupled to the shaft and operable to rotate along with the shaft. The rotor may include a secondary receiver spaced apart from the primary by a predetermined gap. The secondary receiver may be configured to rotate with the rotor along with the shaft. The secondary receiver may include at least one secondary side winding axis that is non-parallel to the central axis.

The foregoing and other embodiments can each optionally include one or more of the following features, alone or in combination. In particular, one embodiment includes all the following features in combination.

In some embodiments, the primary transmitter may be configured to transmit flux to the secondary transmitter in a radial direction relative to the central axis.

In some embodiments, the primary transmitter may include a plurality of primary windings each having a primary side winding axis that is non-parallel to the central axis.

In some embodiments, the plurality of windings may be spaced evenly about the central axis.

In some embodiments, the secondary receiver may include a plurality of secondary windings each having a secondary side winding axis that is non-parallel to the central axis.

In some embodiments, during operation, at at least one moment of time, the primary side winding axis of one of the primary windings may be colinear with the secondary side winding axis of one of the secondary windings.

In some embodiments, the primary transmitter and the secondary receiver each may be implemented in either a unipolar three-phase coil or a bipolar three-phase coil.

In some embodiments, a wound rotor synchronous motor may a rotary transformer according to one or more embodiments described herein. The motor may include an inverter and a resonant primary tuning network. The primary transmitter may be connected to the inverter through the resonant primary tuning network, such that currents through the primary transmitter may create a time varying rotational magnetic field captured by the secondary receiver, so the time varying rotational magnetic field causes a high frequency voltage induced on the secondary receiver. The motor may include a rectifier and rotor windings connected to the secondary receiver through the rectifier.

In some embodiments, an electric vehicle traction system may include the wound rotor synchronous motor.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a rotary transformer according to one embodiment of the present disclosure.

FIG. 2 shows a sectional view of the rotary transformer in FIG. 1.

FIG. 3 shows primary and secondary sides coil assemblies of the rotary transformer in FIG. 1.

FIG. 4 shows a core construction according to one embodiment.

FIG. 5 shows a representative view of a system with a rotary transformer according to one embodiment.

FIG. 6 shows an excitation system according to one embodiment.

FIG. 7 shows a ring assembly according to one embodiment.

FIG. 8 shows a ring assembly according to one embodiment.

FIG. 9 shows a ring assembly according to one embodiment.

FIG. 10 shows a ring assembly according to one embodiment.

FIG. 11 shows a ring assembly according to one embodiment.

FIG. 12 shows a ring assembly according to one embodiment.

FIG. 13 shows a ring assembly according to one embodiment.

FIG. 14 shows a ring assembly according to one embodiment.

FIG. 15 shows a ring assembly according to one embodiment.

FIG. 16 shows a coil winding assembly according to one embodiment.

FIG. 17 shows a coil winding assembly according to one embodiment.

FIG. 18 shows an excitation system according to one embodiment.

FIG. 19 shows several components of the excitation system of FIG. 18.

FIG. 20 shows several components of the excitation system of FIG. 18.

FIG. 21 shows several components of the excitation system of FIG. 18.

FIG. 22 shows several components of the excitation system of FIG. 18.

FIG. 23 shows several components of the excitation system of FIG. 18.

### DESCRIPTION

One embodiment according to the present disclosure includes a high frequency and high-speed polyphase rotary transformer construction for field excitation of WRSMs. For instance, a circuit for a three-phase excitation system and a magnetic coupler construction are described—although as discussed herein, the present disclosure is not limited to a three-phase excitation system, e.g., single-phase excitation systems and multi-phase excitation systems (more or less than three) may also be implemented in conjunction with one or more rotary transformer embodiments described herein. Wirelessly energizing the rotor windings instead of brush/slipring assemblies is enabled by using a three-phase rotary transformer according to one embodiment. A rotary transformer configuration according to one embodiment may reduce the eddy current losses. The rotary transformer may include first and second ferrite backplate discs and metal holders for the rotor that mitigate eddy currents. The first and second metal holders may include one or more of tapered surfaces, laminated ring configurations, surface depressions, and sectored constructions.

### I. Overview

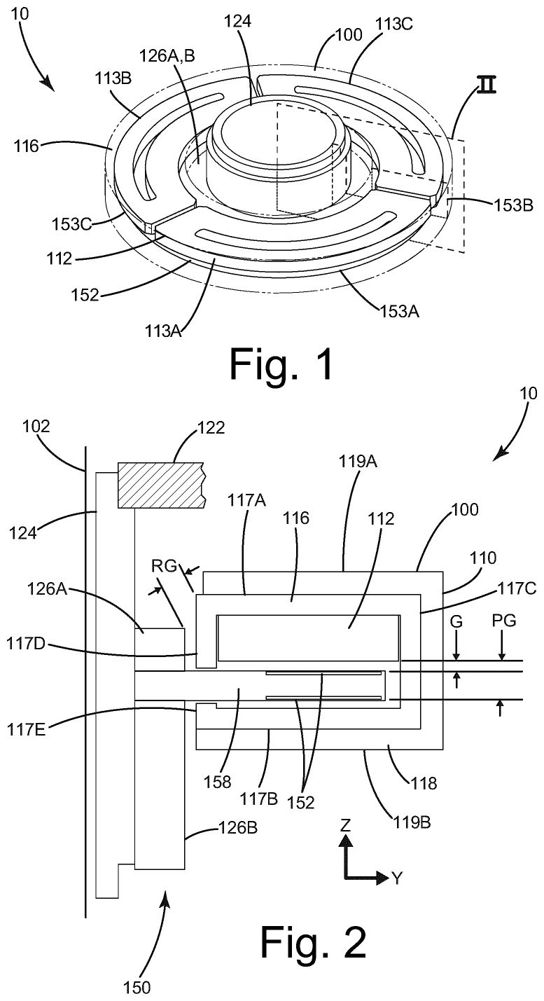

An excitation system 10 in accordance with one embodiment is shown in FIGS. 1-2 including a rotary transformer 100. The rotary transformer 100 may include a stator 110 having a primary transmitter 112 and a primary core 116 (also described as a stator core, which may be a primary ferromagnetic core). The rotary transformer 100 may include a shaft 124 configured to rotate relative to the stator 110 during operation, and a rotor 150 affixed to the shaft 124 that may rotate along with the shaft 124 during operation. In the illustrated embodiment, the rotor 150 and the shaft 124 rotate about a central or primary axis 102 of the stator 110. In the illustrated embodiments, the rotary transformer 100 includes a primary transmitter 112 provided in more than one part that are spaced apart around the primary axis 102, e.g., with first, second, and third primary windings designated 113A, 113B, 113C supported by the primary core 116. Alternatively, the primary transmitter 112 may be a single part—e.g., a single coil—that is spaced apart from a secondary receiver 152.

The rotor 150 may include a secondary receiver 152 that may be spaced apart from the primary transmitter 112 of the stator 110 by a gap G (which may be a predetermined airgap). The secondary receiver 152 may be operable to receive power from (or transmit power to) the primary transmitter 112. The size of the gap G may vary from application to application, and may for instance be from a fraction of a mm to a few millimeters, such as 3, 5 or 10.

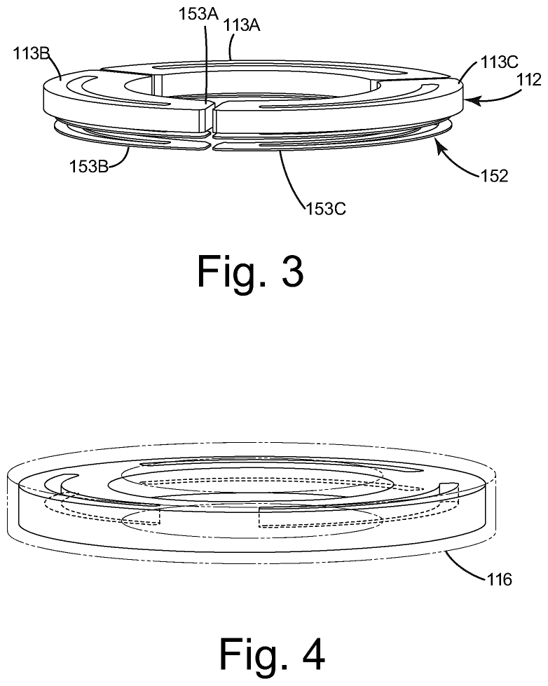

The secondary receiver 152 in one embodiment may include a plurality of parts spaced apart around the primary axis 102, e.g., with first, second, and third secondary windings designated 153A, 153B, 153C. In one embodiment, the first, second, and third primary windings 113A, 113B, 113C and the first, second, and third secondary windings 153A, 153B, 153C may be operable for multi-phase transfer of power and a wireless manner. For instance, in FIG. 3, the first, second, and third primary windings 113A, 113B, 113C may respectively transmit power in A, B, and C phases, which may be received by the first, second, and third secondary windings 153A, 153B, 153C as X, Y, and Z phases, respectively. In one embodiment, the A, B, and C phases may be 120 deg. with respect to each other, and the X, Y, Z phases may likewise be 120 deg. relative to each other.

In an alternative embodiment, the rotary transformer 100 may be configured as a single-phase configuration with a single winding on the primary and secondary sides. An example of such a single winding is shown in FIG. 16 and generally designated 190. The single winding may be provided for the primary transmitter 112 and the secondary receiver 152, respectively, instead of the first, second, and third primary windings 113A, 113B, 113C and the first, second, and third secondary windings 153A, 153B, 153C.

The secondary receiver 152 of the rotor 150 may be supported by a rotor support 158, which may vary from application to application. In one configuration, the rotor support 158 may correspond to a printed circuit board (PCB)—although the present disclosure is not so limited.

The secondary receiver 152 and a portion of the rotor support 158 may be disposed in a stator gap PG defined between internal opposing surfaces of the stator 110. In the illustrated embodiment, the stator gap PG is defined by the configuration of the stator 110, such as between opposing surfaces of 1) a lower surface of the primary transmitter 112 and 2) a confronting surface of the primary core 116. The stator gap PG may be absent in one or more embodiments as described herein. The stator gap PG in one embodiment may be a fraction of a mm to a few millimeters, such as 3, 5, or 10 mm. The stator gap PG and/or the gap G may be sufficiently large, so the rotary transformer 100 is capable of high-speed operation, including, for example, typically up to 36,000 RPM, such as operation equal to or greater than 8,000 RPM, equal to or greater than 10,000 RPM, equal to or greater than 16,000 RPM, equal to or greater than 20,000 RPM, equal to or greater than 25,000 RPM, approximately equal to 30,000 RPM, between 8,000 RPM and 12,000 RPM, between 10,000 RPM and 16,000 RPM, between 10,000 RPM and 20,000 RPM, or between 8,000 RPM and 30,000 RPM.

The rotor 150 may include a support 158, which, as noted, may be a PCB assembly or litz wire-based winding in one embodiment operable to maintain a position of the secondary receiver 152 relative to the gap G and the stator gap PG. In the illustrated embodiment, the support 158 may interface with the shaft 124, such as by being attached to the shaft 124, and may be positioned (e.g., sandwiched) between first and second metal rings 126A, 126B (e.g., aluminum metal rings), which as described herein may mitigate eddy current.

The rotary transformer 100 in one embodiment includes a three-phase primary transmitter 112 and a three-phase secondary side receiver 152, where the primary side is stationary and a secondary side rotates with the rotor 150. Optionally, the angular position of the rotor 150 does not have any impact on the mutual coupling of these windings (i.e., between the primary transmitter 112 and the secondary receiver 152) as the secondary side does not have any ferrite. Primary coils of the primary transmitter 112 may be connected to a high frequency inverter 172 through a resonant tuning network 174 and the currents through these coils may create a time varying rotational magnetic field which can be captured by the secondary coils of the secondary receiver 152. As a result, a high frequency voltage may be induced on the secondary side and secondary coils are connected to the rotor windings 180 through a rectifier 178.

The rotary coupler 100 according to one embodiment is a magnetic coupler configuration that has three individual windings 113A, 113B, 113C, 153A, 153B, 153C on both sides for primary and secondary. Litz wire may be used for primary side windings 113A, 113B, 113C, and this side has a magnetic core material 116 and a backplate 118. Phase coils on the primary side are named A, B, and C for purposes of disclosure. Secondary side windings 153A, 153B, 153C can be constructed either by using Litz wire or a PCB, with the PCB construction shown in shown in FIGS. 1-3. This PCB construction in FIGS. 1-3 has identical winding traces for the secondary side windings 153A, 153B, 153C on both sides, and the secondary side windings 153A, 153B, 153C are internally connected to each other in series.

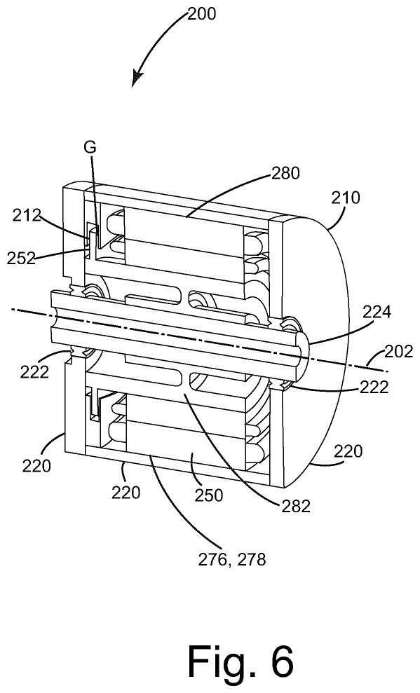

At least one bearing 122 may be disposed on the shaft 124 to facilitate maintaining a position of the rotor 150 and shaft 124 relative to the stator 110. A housing (e.g., an aluminum housing designated 210 in FIG. 6) may be provided to enclose the rotor 150 and the stator 110. The at least one bearing 122 may interface with the housing to facilitate maintaining the position of the rotor 150 and the shaft 124 relative to the stator 110.

The support 158 in one embodiment, as noted herein, may be a PCB that is formed of a nonconductive and nonmagnetic material. The support 158 may be operable to maintain a position of the secondary receiver 152 relative to the primary transmitter 112 at high-speed, such as RPMs greater than 10,000. The material used for the support 158 may vary from application to application, including composite materials based on glass fiber or carbon fiber, G11, BME, thermoplastic, ceramic, and/or cermet. The construction of the support 158 may provide a mechanically strong, nonconductive and nonmagnetic material in one embodiment to facilitate high-speed operation.

The shaft 124 may vary in construction from application to application. For instance, the shaft 124 may be metallic material (e.g., stainless steel) in one embodiment, whereas in another embodiment, the shaft 124 may be nonconductive material. As another example, the shaft 124 may be nonmagnetic in addition to or alternative to being a metallic material or a nonconductive material.

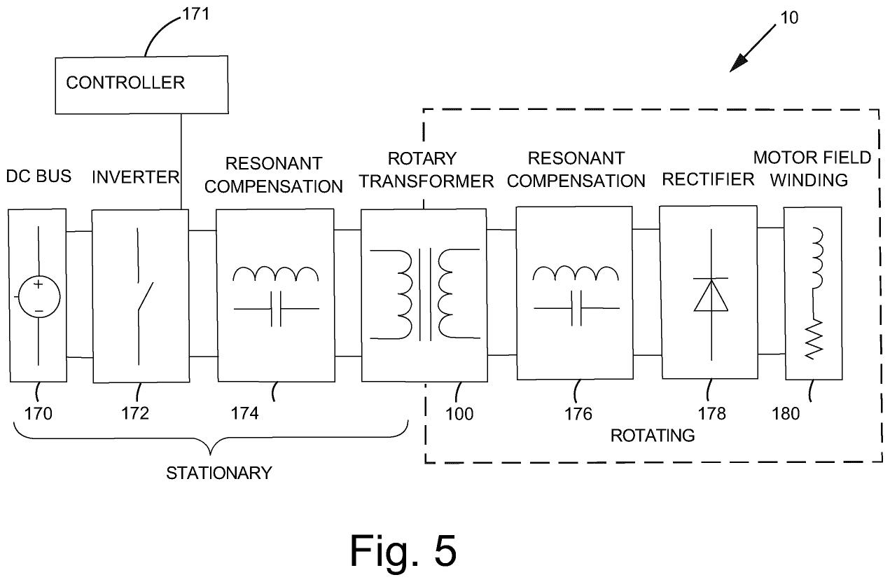

As depicted in FIG. 5, in one embodiment, the excitation system 10 may include a primary compensation circuit 174 that is electrically coupled to the primary transmitter 112 of the stator 110. The primary compensation circuit 174 may be configured to be in resonance with the primary transmitter 112. The excitation system 10 may also include a secondary compensation circuitry 176 electrically coupled with the secondary receiver 152 of the rotor 150. The secondary compensation circuitry 176 may be mechanically coupled with the rotor 150 to rotate along with the rotor 150, and where the secondary compensation circuitry 176 is configured to be in resonance with the secondary receiver 152.

The primary core 116 may be one or more of ferrite, soft magnetic composite, or laminated electric steel. In the illustrated embodiment of FIG. 2, the primary core 116 has a C-shaped cross section with an upper portion 117A spaced from a lower portion 117B and an outer circumferential portion 117C therebetween that joins the upper and lower portions 117A, 117B. The primary core 116 may include an upper inner circumferential portion 117D and a lower inner circumferential portion 117E respectively coupled to the upper portion 117A and the lower portion 117B. The upper inner circumferential portion 117D and a lower inner circumferential portion 117E may be spaced apart to provide clearance to dispose the support 158 and the secondary receiver 152 between the upper portion 117A and the lower portion 117B.

The primary transmitter 112 may be disposed between the upper portion and the lower portion 117A, 117B of the primary core 116. In one configuration, the primary transmitter 112 may be disposed between the inner circumferential portion 117D and the outer circumferential portion 117C of the primary core 116.

In one embodiment, a backplate 118 or core support may be provided with a C-shaped cross-section, similar in some respects to the primary core 116. For instance, the backplate 118 may include an upper portion 119A spaced from a lower portion 119B and an outer circumferential portion 119C therebetween that joins the upper and lower portions 119A, 119B.

In one embodiment, the primary transmitter 112 and the secondary receiver 152 may be arranged to be coaxially aligned relative to the central axis 102. The primary transmitter 112 and the secondary receiver 152 are disposed with opposing surfaces arranged in a confronting relationship so that the secondary receiver 152 rotates relative to the primary transmitter 112. The space between the confronting surfaces may correspond to the gap G.

The construction of the primary transmitter 112 and/or the secondary receiver 152 may vary from application to application. In the illustrated embodiment, the primary transmitter 112 and the secondary receiver 152 are constructed from potted Litz wire.

In one embodiment, as described herein, the primary transmitter 112 and the secondary receiver 152 may correspond respectively to a primary transmitter assembly and a secondary receiver assembly that each include a plurality of coils, such as a plurality of primary coils 113A, 113B, 113C and a plurality of secondary coils 153A, 153B, 153C that form a polyphase transmitter and/or receiver in a wireless power transfer system.

The term “polyphase” used herein refers to the transmitter and/or receiver in a wireless power transfer system having more than one phase. A polyphase system may rotate the field to transfer power. Examples of polyphase systems are described in U.S. Pat. No. 11,936,199 to Pries et al., entitled POLYPHASE WIRELESS POWER TRANSFER SYSTEMS, COIL ASSEMBLIES AND RESONANT NETWORKS, filed Jan. 2, 2020, issued Mar. 19, 2024—the disclosure of which is incorporated by reference herein in its entirety.

Polyphase configurations of the primary transmitter 112 and the secondary receiver 152 are shown in further detail in FIG. 3. The depicted configurations are unipolar—however, the present disclosure is not so limited and other configurations, such as a bipolar configuration may be utilized. An example bipolar winding configuration is shown in FIG. 17, which shows an example of a three-phase bipolar coil assembly in a single layer with a plurality of coils 191A+, 191A−, 192B+, 192B−, 193C+, 193C−. Each coil of the single layer assembly occupies one-sixth of the circumference of the layer, e.g., 60°. The coils having one polarity, e.g., A+, B+ and C+, are arranged opposite the coils having another polarity, e.g., A−, B−, and C−.

In the illustrated embodiment, each coil of the assemblies occupies one-third of the circumference of the assembly, e.g., 120°. The coils 113A, 113B, 113C, 153A, 152B, 152C may include wire wrapped via a winding guide, and the number of turns, layers, and gauge, e.g., AWG, may vary depending on the application including target power density and target size and height of the assembly. As depicted, the primary coils 113A, 113B, 113C are disposed in a single layer configuration, and the secondary coils 153A, 153B, 153C are disposed in a two-layer configuration—the number of layers and construction may vary. The coils may be made of Litz wire.

The first and second metal rings 126A, 126B may be disposed on opposite sides of the support 158. The first and/or second metal rings 126A, 126B may be configured to mitigate eddy current in the rotor 150.

As depicted, the first and second metal rings 126A, 126B are provided in a confronting relationship with the inner circumferential surface of the stator 110, spaced therefrom by a gap RG. However, the first and second metal rings 126A, 126B may be positioned differently depending on the application. For instance, the first and second metal rings 126A, 126B may be positioned to fit within the stator gap PG of the stator 110.

The respective thicknesses of the first and second metal rings 126A, 126B may also vary from application to application. In the illustrated embodiment, the second metal ring 126B is thicker than the first metal ring 126A, e.g., one, two, or three or more times in thickness. Example thicknesses for the first metal ring 126A may be a few millimeters, e.g., 2, 3, or 5 mm, and example thicknesses for the second metal ring 126B may be a few millimeters, e.g., 2, 3, or 4 mm. In one configuration, the first metal ring 126A—i.e., the thinner ring—may be positioned on the same side as the primary transmitter 112 relative to the secondary receiver 152. Additionally, or alternatively, the first metal ring 126A may be sufficiently thin so that a surface of the first metal ring 126A opposite the support 158 is at least one of 1) coplanar with the primary transmitter 112 and 2) closer to the support 158 than a surface of at least one of the primary core 116 and the backplate 118 opposite a surface thereof that faces the secondary receiver 152.

### II. Ring Construction

As described herein, the rotor 150 includes first and second metal rings 126A, 126B. For purposes of disclosure, the first and second metal rings 126A, 126B in several configurations are shown substantially identical to each other. These two rings may vary in construction from application to application and need not be the same. For instance, the first metal ring 126A may be configured according to one or more embodiments described herein, and the second metal ring 126B may be configured according to one or more different embodiments described herein.

As described herein, the ring construction of the rotor 150 mitigates eddy current loss. According to one embodiment, eddy current loss on first and second metal rings 126A, 126B is nearly zero due to the rotational magnetic field. In contrast, for conventional single-phase rotary transformer applications, there are eddy current losses induced on the electrically conductive materials such as aluminum. This category of losses conventionally corresponds to the largest losses in the whole rotary transformer assembly.

The rotary transformer 100 in the illustrated embodiment is shown as a polyphase transformer configuration. It is to be understood, however, that the rotary transformer 100 may be configured differently depending on the application, including a single-phase transformer configuration. The polyphase transformer configuration, however, may provide enhanced surface loss distribution relative to the single-phase transformer configuration. For instance, the surface loss density distribution on the first and second metal rings 126A, 126B may be 1000 times less for the polyphase transformer configuration relative to the single-phase transformer configuration.

The rotary transformer 100 may provide a polyphase rotary transformer construction that can be used for field excitation of WRSM electric machines. The rotary transformer 100 may be compact and lightweight and can be used for high-frequency and high-speed applications. Compared to a conventional single-phase rotary transformer construction, a polyphase rotary transformer 100 according to one embodiment enables transfer of higher excitation power levels to the rotor windings 180. Additionally, as described herein, the polyphase rotary transformer 100 is implemented as part of a unipolar polyphase system—however, the present disclosure is not so limited. For instance, the rotary transformer 100 may be configured for a bipolar polyphase system instead of a unipolar polyphase system.

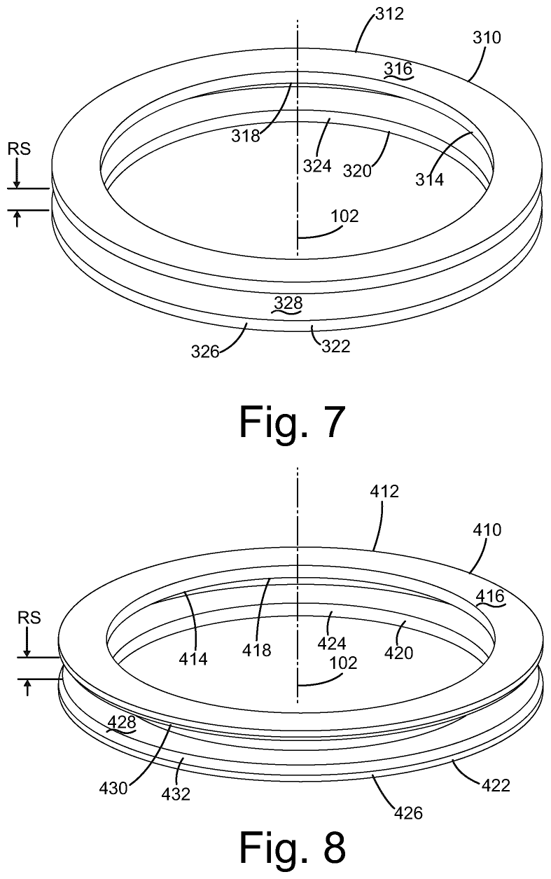

The first and second metal rings 126A, 126B according to various embodiments and configurations are shown in FIGS. 7-15, with the first metal ring 126A being designated by 310, 410, 510, 610, 710, 810, 910, 1010, 1110 and the second metal ring being designated by 320, 420, 520, 620, 720, 820, 920, 1020, 1120. The first and second metal ring constructions of FIGS. 7-15 may be used in conjunction with single phase systems or multi-phase systems (e.g., a three-phase system).

In the illustrated embodiment of the FIG. 7, the first metal ring 310 includes an inner circumferential surface 314 that faces the shaft 124, and an outer circumferential surface 312 opposite the inner circumferential surface 314. An upper and lower surface 316, 318 may be provided between the inner and outer circumferential surface is 314, 312, with the upper surface 316 providing an outer surface and the lower surface 318 providing an inner surface relative to the support 58 of the rotor 150. The lower surface 318 may be provided in proximity to, optionally in contact with, the support 158 according to one or more embodiments described herein.

Similar to the first metal ring 310, the second metal ring may include an inner circumferential surface 324 that faces the shaft 124. The second metal ring may also include an outer circumferential surface 322 opposite the inner circumferential surface 324. An upper and lower surface 328, 326 may be provided between the inner and outer circumferential surfaces 324, 322, with the upper surface 328 providing an inner surface and the lower surface 326 providing an outer surface relative to the support 158 of the rotor 150.

The inner surfaces of the first and second metal rings 310, 320 may be spaced apart by a ring space RS, which may vary from application to application, e.g., 2, 3, or 5 mm. In one embodiment, the ring space RS may correspond substantially to the thickness of the support 158 of the rotor 150, so that the first and second metal rings 310, 320 sandwich and contact both sides of the support 158.

The diameter of the inner circumferential surfaces 314, 324 may correspond substantially to the diameter of the shaft 124.

### A. Tapered Surfaces

Turning to FIG. 8, the first metal ring 410 and the second metal ring 420 are similar to the first and second metal rings 310, 320 in many respects, including inner circumferential surfaces 414, 424 that face the shaft 124, outer circumferential surfaces 412, 422, upper surfaces 416, 428, lower surfaces 418, 426, and a ring space RS between the first and second metal rings 410, 420, similar respectively to the inner circumferential surfaces 314, 324 that face the shaft 124, outer circumferential surfaces 312, 322, upper surfaces 316, 328, lower surfaces 318, 326, and the ring space RS.

The first and second metal rings 410, 420 differ from the first and second metal rings 310, 320 with a tapered surfaces 430, 432 or tapered edges respectively between the outer circumferential surfaces 412, 422 and the inner surfaces (e.g., the lower surface 418 and the upper surface 428). The amount of taper may vary from application to application. Further, it is noted that, depending on the application, the tapered surface 430, 432 may be provided on one or both of the first and second metal rings 410, 420, and, additionally, or alternatively, the tapered surface may be provided between one or more of the outer circumferential surfaces 412, 422 and the outer surfaces (e.g., the upper surface 416 of the first metal ring 410 and the lower surface 426 of the second metal ring 420).

### B. Radially Spaced Rings

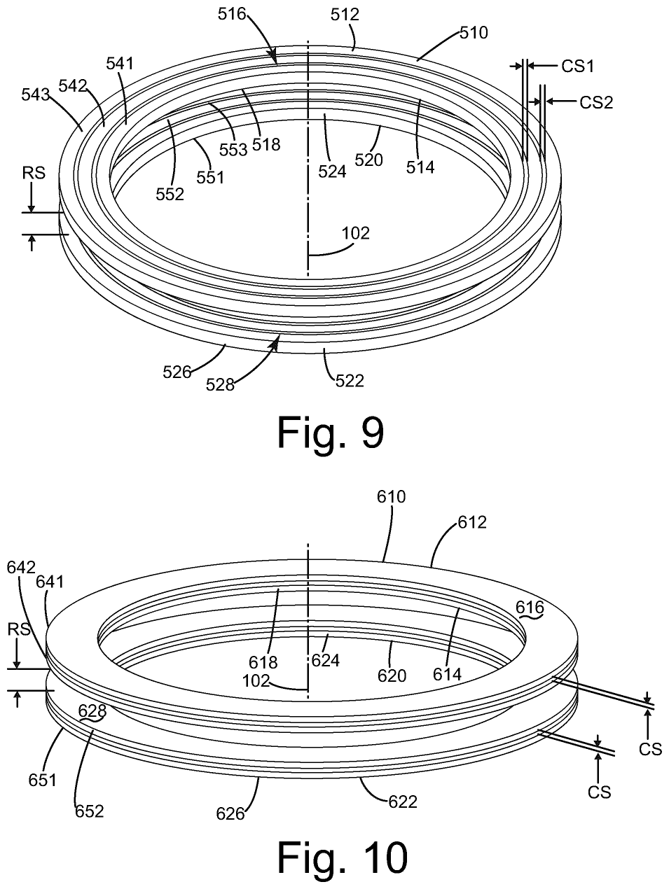

Turning to FIG. 9, the first metal ring 510 and the second metal ring 520 are similar to the first and second metal rings 310, 320 in many respects, including inner circumferential surfaces 514, 524 that face the shaft 124, outer circumferential surfaces 512, 522, upper surfaces 516, 528, lower surfaces 518, 526, and a ring space RS between the first and second metal rings 510, 520, similar respectively to the inner circumferential surfaces 314, 324 that face the shaft 124, outer circumferential surfaces 312, 322, upper surfaces 316, 328, lower surfaces 318, 326, and the ring space RS.

The first and second metal rings 510, 520 differ from the first and second metal rings 310, 320 with the first metal ring 510 being formed by a plurality of radially spaced rings 541, 542, 543 relative to the central axis 102, and the second metal ring 520 being formed by a plurality of radially spaced rings 551, 552, 553 relative to the central axis 102. The spacing CS1, CS2 between the radially spaced rings 541, 542, 543, 551, 552, 553 may vary from application to application. In one embodiment, the spacing CS1, CS2 may be based on the radially spaced rings 541, 542, 543, 551, 552, 553 being laminated to form the first and second metal rings 510, 520, respectively. For instance, the spacing CS1, CS2 may be based on whether any type of material (e.g., a binder) is provided between the radially spaced rings 541, 542, 543, 551, 552, 553.

### C. Axially Spaced Rings

In the illustrated embodiment of FIG. 10, the first metal ring 610 and the second metal ring 620 are similar to the first and second metal rings 310, 320 in many respects, including inner circumferential surfaces 614, 624 that face the shaft 124, outer circumferential surfaces 612, 622, upper surfaces 616, 628, lower surfaces 618, 626, and a ring space RS between the first and second metal rings 610, 620, similar respectively to the inner circumferential surfaces 314, 324 that face the shaft 124, outer circumferential surfaces 312, 322, upper surfaces 316, 328, lower surfaces 318, 326, and the ring space RS.

The first and second metal rings 610, 620 differ from the first and second metal rings 310, 320 with the first metal ring 610 being formed by a plurality of axially spaced rings 641, 642 relative to the central axis 102, and the second metal ring 620 being formed by a plurality of axially spaced rings 651, 652 relative to the central axis 102. The respective spacing CS1, CS2 between the axially spaced rings 641, 642, 651, 652 may vary from application to application. In one embodiment, the spacing CS1, CS2 may be based on the axially spaced rings 641, 642, 651, 652, being laminated to form the first and second metal rings 610, 620, respectively. For instance, the spacing CS1, CS2 may be based on whether any type of material (e.g., a binder) is provided between the axially spaced rings 641, 642, 651, 652.

### D. Surface Depressions

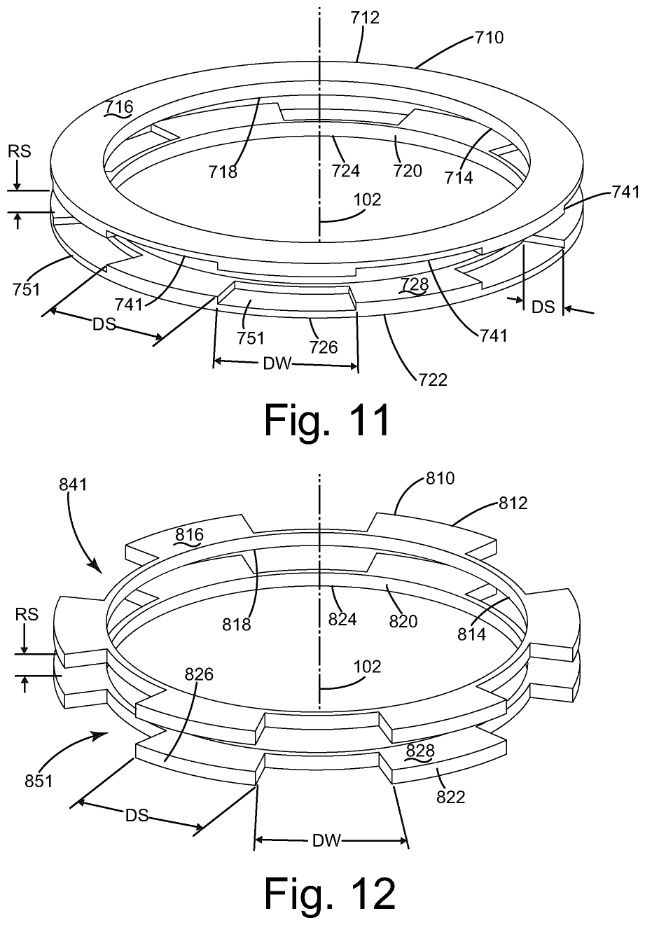

In the illustrated embodiment of FIG. 11, the first metal ring 710 and the second metal ring 720 are similar to the first and second metal rings 310, 320 in many respects, including inner circumferential surfaces 714, 724 that face the shaft 124, outer circumferential surfaces 712, 722, upper surfaces 716, 728, lower surfaces 718, 726, and a ring space RS between the first and second metal rings 710, 720, similar respectively to the inner circumferential surfaces 314, 324 that face the shaft 124, outer circumferential surfaces 312, 322, upper surfaces 316, 328, lower surfaces 318, 326, and the ring space RS.

The first and second metal rings 710, 720 differ from the first and second metal rings 310, 320 with the second metal ring 720 including a plurality of depressions 751 that provided on the inner surface of the (e.g., the upper surface 728). The plurality of depressions 751 may each have a width DW and may be spaced apart axially around the circumference of the first metal ring by a space DS. The width DW and the space DS may be different and may vary from application to application. Example values include a few tens of millimeters, e.g., 10, 15, 20, 25 mm, etc. The depth of the depressions 751 between the upper surface 728 and the lower surface 726 may vary from application to application and between the first and second metal rings 710, 720. Further, the radial size RD of the depression 741 (from the outer circumferential surface 722 to the inner circumferential surface 724) may vary from application to application, and may correspond to a portion or entirety of the distance between the outer and inner circumferential surfaces 722, 724.

The plurality of depressions 741 of the first metal ring 710 may be similar to the plurality of depressions 751 of the second metal ring 720, with the plurality of depressions 741 being disposed on the inner surface (e.g., the lower surface 718) of the first metal ring 710. Optionally, the first and second metal rings 710, 720 are oriented relative to each about the central axis 102 and the lower surface 718 of the first metal ring 710 is rotated with respect to the upper surface 728 of the second metal ring 720 so that each of the plurality of depressions 741 of the first metal ring 710 is rotated between first and second depressions of the plurality of depressions 751 of the second metal ring 720 or so that a center of each of the plurality of depressions 741 of the first metal ring 710 is rotated between first and second depressions of the plurality of depressions 751 of the second metal ring 720, optionally equidistant between the centers of such first and depressions of the plurality of depressions 751 of the second metal ring 720.

The plurality of depression 741, 751 of the first and second metal rings 710, 720 may form periodic recessions on the surfaces of the first and second metal rings 710, 720 that face each other. Optionally, as described herein, the first and second metal rings 710, 720 may be angularly shifted by one-half pitch with respect to the recessions.

### E. Sectored Rings

In the illustrated embodiments of FIGS. 12 and 14, the first metal ring 810, 1010 and the second metal ring 820, 1020 are similar to the first and second metal rings 310, 320 in many respects, including inner circumferential surfaces 814, 824, 1014, 1024 that face the shaft 124, outer circumferential surfaces 812, 822, 1012, 1022, upper surfaces 816, 828, 1016, 1028, lower surfaces 818, 826, 1018, 1026, and a ring space RS between the first and second metal rings 810, 820, 1010, 1020, similar respectively to the inner circumferential surfaces 314, 324 that face the shaft 124, outer circumferential surfaces 312, 322, upper surfaces 316, 328, lower surfaces 318, 326, and the ring space RS.

The first and second metal rings 810, 820, 1010, 1020 differ from the first and second metal rings 310, 320 with the first and second metal rings 810, 820, 1010, 1020 including a plurality of notches 841, 851, 1041, 1051, similar to the depressions 741, 751 with the depth being completely through the first and second metal rings 810, 820, 1010, 1020 from the inner to outer surfaces. Similarly, the plurality of notches 841, 851, 1041, 1051 may each have a width DW and may be spaced apart axially around the circumference of the first and second metal ring 810, 820, 1010, 1020 by a space DS. The width DW and the space DS may be different and may vary from application to application. Example values include a few tens of millimeters, e.g., 10, 15, 20, 25 mm, etc. For instance, the space DS for the first and second metal rings 1010, 1020 is smaller than the space DS for the first and second metal rings 810, 820, providing a greater number of notches 1041, 1051 for the first and second metal rings 1010, 1020 relative to the number of notches 841, 851 for the first and second metal rings 810, 820. In this way, the first and second metal rings 810, 820 may form coarse-pitch sectored rings, and the first and second metal rings 1010, 1020 may form fine-pitch sectored rings.

The width DW and the space DS may be defined in an alternative manner by a pitch size with respect to the notches 841, 851, 1041, 1051. The notches 841, 851, 1041, 1051 may have be arranged according to a predetermined pitch size, optionally within a predetermined pitch size range, such as a few tens of millimeters, e.g., 10, 15, 20, 25 mm, etc. Together, the space DS and the width DW may also define the plurality of notches 841, 851, 1041, 1051 being arranged or distributed at predetermined angular intervals about the circumference of the first and second metal rings 810, 820, 1010, 1020.

Further, the radial size RD of the plurality of notches 841, 851, 1041, 1051 (from the outer circumferential surface 812, 822, 1012, 1022 to the inner circumferential surface 814, 824, 1014, 1024 may vary from application to application, and may correspond to a portion of the distance between the outer and inner circumferential surfaces 812, 822, 1012, 1022, 814, 824, 1014, 1024.

The shape of the notches 841, 851, 1041, 1051 may vary from application to application. In the illustrated embodiment, the notches 841, 851, 1041, 1051 include a width DW and a radial size RD, with the interior surface 843, 853 having a curvature defined by a radius relative the central axis 102 and greater than a radius of the inner circumferential surface 814, 824. However, the present disclosure is not so limited—any shape may be provided, including but not limited to rectangular, trapezoidal, or arcuate (or other suitable cross-sectional profiles).

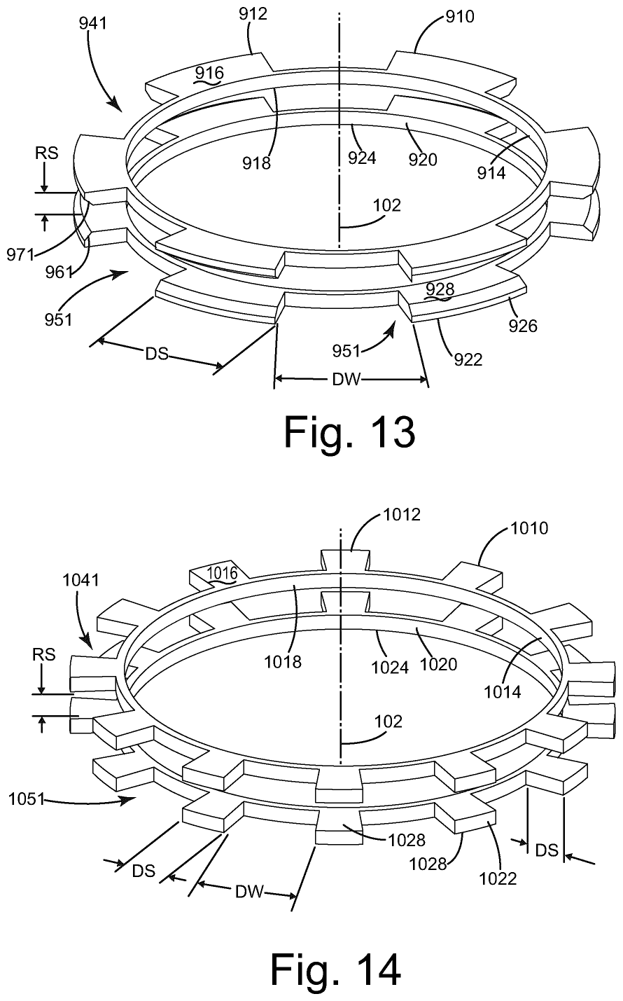

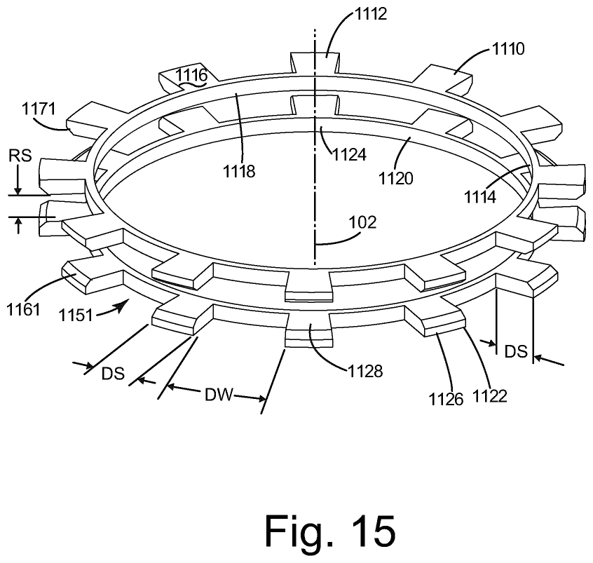

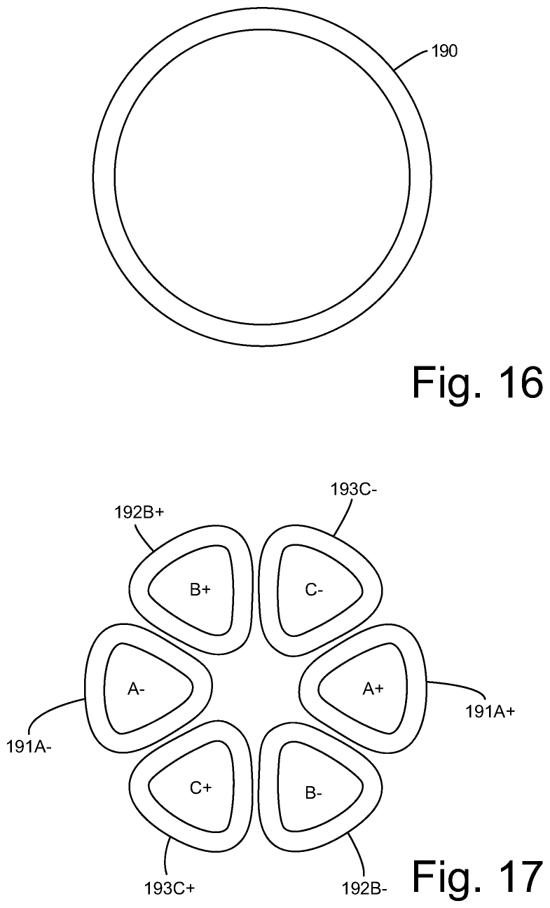

In the illustrated embodiments of FIGS. 13 and 15, the first metal ring 910, 1110 and the second metal ring 920, 1120 are similar to the first and second metal rings 810, 820, 1010, 1020 in many respects, including inner circumferential surfaces 914, 924, 1114, 1124 that face the shaft 124, outer circumferential surfaces 912, 922, 1112, 1122, upper surfaces 916, 928, 1116, 1128, lower surfaces 918, 926, 1118, 1126, a ring space RS between the first and second metal rings 910, 920, 1110, 1120, and a plurality of notches 941, 951, 1141, 1151, similar respectively to the inner circumferential surfaces 814, 824, 1014, 1024 that face the shaft 124, outer circumferential surfaces 812, 822, 1012, 1022, upper surfaces 816, 828, 1016, 1028, lower surfaces 818, 826, 1018, 1026, the ring space RS, and the plurality of notches 841, 851, 1041, 1051.

The first and second metal rings 910, 920, 1110, 1120 differ from the first and second metal rings 810, 820, 1010, 1020 with tapered surfaces 961, 971, 1161, 1171 respectively between the outer circumferential surfaces 912, 922, 1112, 1122 and the inner surfaces (e.g., the lower surface 918, 1118 and the upper surface 926, 1126). The amount of taper may vary from application to application. Further, it is noted that, depending on the application, the tapered surface may be provided on one or both of the first and second metal rings 910, 920, 1110, 1120, and, additionally, or alternatively, the tapered surface may be provided between one or more of the outer circumferential surfaces 912, 922, 1112, 1122 and the outer surfaces (e.g., the upper surface 916, 1116 of the first metal ring 910, 1110 and the lower surface 926, 1126 of the second metal ring 920, 1120).

In one embodiment, the first and second metal rings 910, 920 may form coarse-pitch sectored rings with tapered edges or tapered surfaces, and the first and second metal rings 1110, 1120 may form fine-pitch sectored rings with tapered edges or tapered surfaces.

### III. Excitation System

The excitation system in the illustrated embodiment of FIGS. 2 and 5 may include a DC bus 170, an inverter 172, a rectifier 178 and a motor field winding 180, primary compensation circuitry 174, secondary compensation circuitry 176, and the rotary transformer 100. The DC bus 170 may be operably coupled to a power source to deliver power to an inverter 172 that is operable to selectively power the primary compensation circuitry 174 and a transmitter of the rotary transformer 100.

In the illustrated embodiment, the motor field winding 180 is coupled to the rectifier 178, which receives power from a receiver of the rotary transformer 100 and the secondary compensation circuitry 176. The rectifier 178 and the motor field winding 180 may be mechanically coupled with the rotor 150 to rotate along with the rotor 150 and operation.

As described herein, the primary compensation circuitry 174 and the secondary compensation circuitry 176 may vary from application to application. As an example, the primary compensation circuitry 174 or the secondary compensation circuitry 176, or both, may be configured as an LCC circuit, an LCL circuit, a series circuit, parallel circuit, or a direct connection, or any combination thereof. Various circuit topologies for such compensation circuitry are described in U.S. Pat. No. 12,224,113 to Raminosoa et al., entitled WIRELESS EXCITATION SYSTEM, filed May 12, 2021, issued Feb. 11, 2025—the disclosure of which is incorporated herein by reference in its entirety.

Although the rotary transformer 100 is described in conjunction with providing power wirelessly to the secondary receiver 152 of the rotor 150 in order to provide power for rotating the rotor 150, it is to be understood that the rotor 150 may be operated as a generator such that electrical power is transferred from a winding of the rotor 150 to a winding of the stator 110, and from the winding of the stator 110 to a load.

In the illustrated embodiment of FIG. 6, a rotary transformer 200 is shown in accordance with one embodiment. The rotary transformer 200 is similar in some respects to the rotary transformer 100 described in conjunction with the illustrated embodiments of FIGS. 1-5 and 7-15. Configurations shown in FIGS. 7-15 are applicable to both single and three-phase rotary transformer arrangements. For purposes of disclosure, parts of the rotary transformer 200 that are similar in name to parts of the rotary transformer 100 are designated by reference numbers that share the same first two digits (e.g., 2XX and 1XX designate similarly named components).

The rotary transformer 200 in the illustrated embodiment may form part of the excitation system as described herein. The rotary transformer 200 may include a primary transmitter 212 and a secondary receiver 252 separated by a gap, defined at least in part by a gap G between opposing surfaces of the rotor 250 and the stator 210.

The rotary transformer 200 in the illustrated embodiment includes a shaft 224 coupled to the rotor 250 that rotates about the central axis 202. First and second bearings 222 may be provided to support the shaft 224 relative to the stator 210. The rotor 250 may include a rotor field winding 280 and a rotor hub 282 operable to support the rotor field winding 280 and power electronics 276, 278. The secondary receiver 252 may provide electrical power to the power electronics 262, 278, which rotate with the rotor 250.

A housing 220 (e.g., an aluminum housing) may be provided to enclose the rotor 250 and the stator 210. The first and second bearings 222 may interface with the housing 220 to facilitate maintaining the position of the rotor 250 and the shaft 224 relative to the stator 210.

### IV. Alternative Excitation System

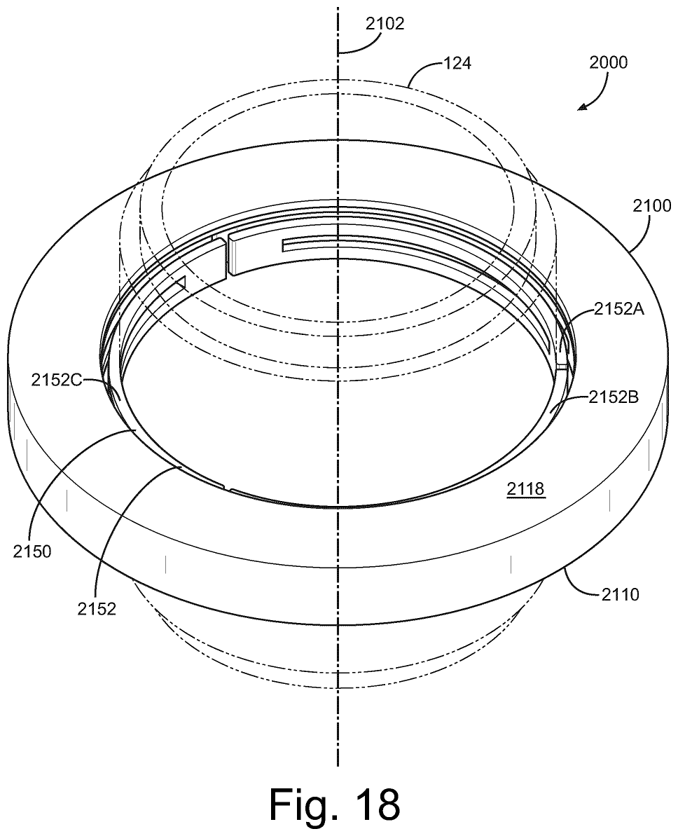

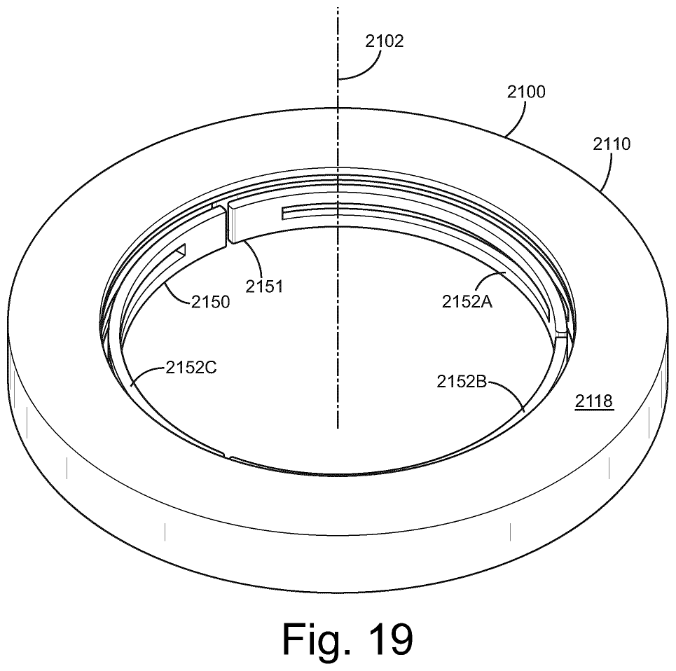

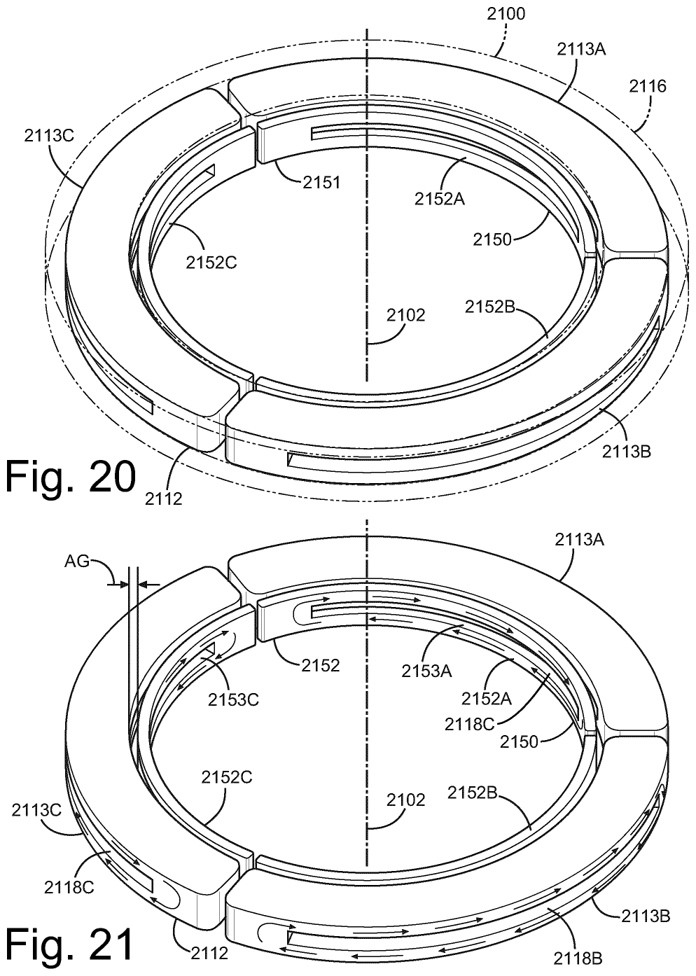

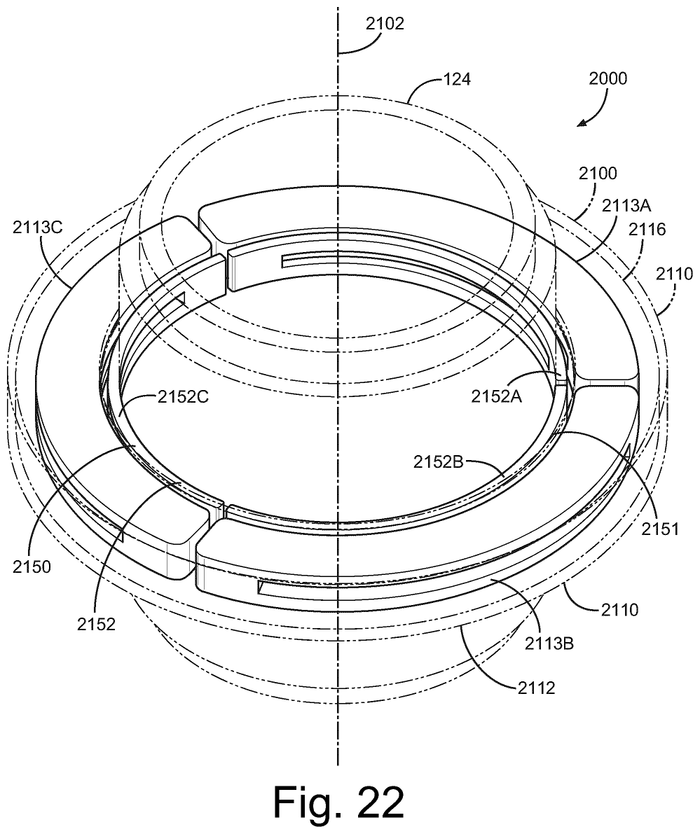

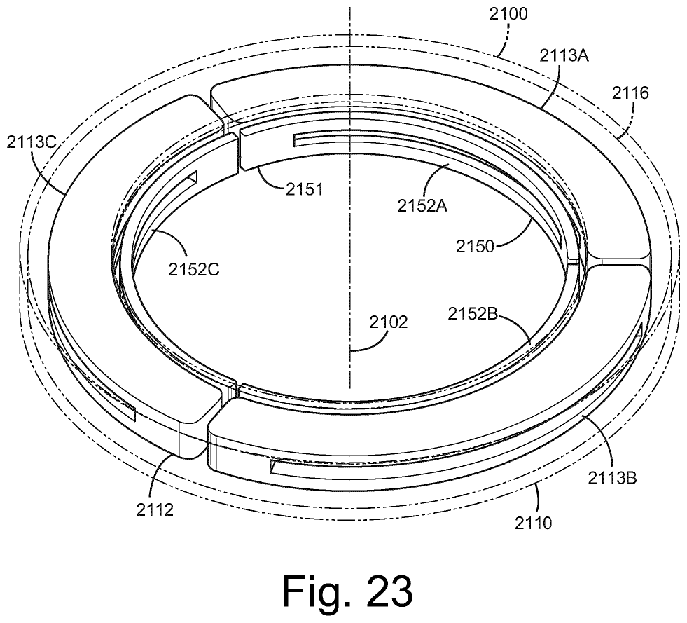

In the illustrated embodiment of FIGS. 18-23, an alternative construction for an excitation system is shown and generally designated 2000. The excitation system 2000 includes a rotary transformer 2100 with a stator 2110 that includes a primary transmitter 2112 capable of transmitting power wirelessly to a secondary receiver 2151. The rotary transformer 2100 may include a shaft 124 similar to the shaft 124 described in conjunction with the excitation system 10, and similarly, a rotor 2150 may be affixed to the shaft 124 and configured to rotate along with the shaft 124 during operation. The rotary transformer 2100 for the excitation system 2000 may be incorporated into or incorporate aspects of one or more embodiments described herein. For instance, the rotary transformer 2100 may be incorporated into the construction of FIG. 6 as well as in conjunction with circuitry of FIG. 5. Likewise, the rotary transformer 2100 may include first and second metal rings constructed and arranged relative to the secondary receiver 2151 according to one or more embodiments described herein.

In the illustrated embodiment, the rotor 2150 and the shaft 124 rotate about a central or primary axis 2102 of the stator 2110. In the illustrated embodiments, the rotary transformer 100 includes a primary transmitter 112 provided in multiple parts that are spaced apart around the primary axis 2102, e.g., with first, second, and third primary windings designated 2113A, 2113B, 2113C supported by a primary core 2116 and a backplate 2118. Alternatively, the primary transmitter 2112 may be a single part—e.g., a single coil—that is spaced apart from a secondary receiver 2151.

As described herein, the rotor 2150 may include a secondary receiver 2151 that may be spaced apart from the primary transmitter 2112 of the stator 2110. The secondary receiver 2151 may be spaced apart from the primary transmitter 2112 by a gap AG (which may be a predetermined airgap). The secondary receiver 2151 may be operable to receive power from (or transmit power to) the primary transmitter 2112. The size of the gap AG may vary from application to application, and may for instance be from a fraction of a mm to a few millimeters, such as 3, 5 or 10.

The secondary receiver 2151 in one embodiment may include a plurality of parts spaced apart around the primary axis 2102, e.g., with first, second, and third secondary windings designated 2152A, 2152B, 2152C. In one embodiment, the first, second, and third primary windings 2113A, 2113B, 2113C and the first, second, and third secondary windings 2152A, 2152B, 2152C may be operable for multi-phase transfer of power and a wireless manner. For instance, as shown in FIG. 21, the first, second, and third primary windings 2113A, 2113B, 2113C may respectively transmit power in A, B, and C phases, which may be received by the first, second, and third secondary windings 2152A, 2152B, 2152C as X, Y, and Z phases, respectively, with current flow for such phases shown in the depicted embodiment. In one embodiment, the A, B, and C phases may be 120 deg. with respect to each other, and the X, Y, Z phases may likewise be 120 deg. relative to each other. The physical placement each of the first, second, and third primary windings 2113A, 2113B, 2113C may be such that the first, second, and third primary windings 2113A, 2113B, 2113C are distributed evenly about the central axis 2102, e.g., at 120 deg. intervals.

The secondary receiver 2151 may be formed by a PCB assembly or litz wire-based winding in one embodiment operable to maintain a position of the secondary receiver 2151 relative to the gap AG and the primary transmitter 2112. In one embodiment, the secondary receiver 2151 may interface with the shaft 124, such as by being attached to or coupled to the shaft 124, and may be positioned (e.g., sandwiched) between first and second metal rings, similar to the first and second metal rings 126A, 126B (e.g., aluminum metal rings) according to one embodiment, which as described herein may mitigate eddy current.

The rotary transformer 2100 according to one embodiment is a magnetic coupler configuration that has three individual windings 2113A, 2113B, 2113C, 2152A, 2152B, 2152C on both primary and secondary sides. Litz wire may be used for primary side windings 113A, 113B, 113C. Phase coils on the primary side are named A, B, and C for purposes of disclosure. Secondary side windings 153A, 153B, 153C can be constructed either by using Litz wire or a PCB.

The winding axes of the primary windings 2113A, 2113B, 2113C are shown in FIG. 21 and designated 2118A, 2118B, 2118C, and the winding axes of the secondary windings 2152A, 2152B, 2152C are also shown in FIG. 21 and designated 2153A, 2153B, 2153C. Current may flow within the primary and secondary windings about the winding axes 2113A, 2113B, 2113C, 2153A, 2153B, 2153C in response to supply of power to the primary windings 2113A, 2113B, 2113C and receipt of power in the secondary windings 2152A, 2152B, 2152C via transfer of such power wirelessly from the primary windings 2113A, 2113B, 2113C.

The rotor 2150 in the illustrated embodiments includes a primary transmitter 2112 and a secondary receiver 2151 arranged to move relative to each other about the primary axis 2102, e.g., the secondary receiver 2151 rotates with the shaft 124 about the primary axis 2102 and relative to the primary transmitter 2112, which is stationary. The rotor 150 for the excitation system 10, as described herein, may include a primary transmitter 112 and a secondary receiver 152 operable to move relative to each other in a similar manner, e.g., the secondary receiver 152 rotates with the shaft 124 about the primary axis 102 and relative to the primary transmitter 112, which is stationary. However, the rotor 2150 is different from the rotor 150, at least for the reason that the winding axes 2113A, 2113B, 2113C, 2153A, 2153B, 2153C are non-parallel to the primary axis 2102, e.g., orthogonal to or normal to the primary axis 2102, and e.g., the winding axes 2113A, 2113B, 2113C, 2153A, 2153B, 2153C may be aligned with each other so that, during operation, at at least one moment of time, the primary winding axis 2113A is colinear with the secondary winding axis 2153A. Put differently, rotary transformer 2100 (e.g., a polyphase rotary-transformer) is configured for a radial-flux configuration, in which the primary windings generate a radial magnetic field across the gap AG in a radial direction that links the circumferential secondary windings and induces voltage. The rotor 150 may be configured for axial flux generation with the primary windings generating an axial magnetic field across the gap G in an axial direction parallel to the primary axis 102.

### V. Control

The excitation system 10 in accordance with one embodiment, as described herein, may be controlled in a variety of ways.

As noted, the secondary side (rectifier side) of the rotary transformer 100 rotates with the rotor 150 (see e.g., FIGS. 1 and 2). Therefore, measurement access to the secondary side variables may be limited—i.e., access may be limited to the secondary current and the secondary capacitor voltage for the purpose of control. The regulation of the flux generated by the field winding may be achieved by regulating the secondary current. However, in one embodiment, in the absence of any access to the secondary current, the indirect control of the flux via the primary side state variables may be utilized. For instance, the primary current, the primary capacitor voltage, or a combination thereof may form the basis for control over the excitation system 10.

A controller 171 or control system may be provided in conjunction with the excitation system 10 to control operation of the primary side. For instance, the controller 171 may control switching circuitry of the inverter 172 to supply power in a controlled manner to the primary transmitter 112 of the rotary transformer 100. The controller 171 may receive feedback via one or more sensors and use this feedback as a basis for controlling operation of the excitation system 10. The one or more sensors, as noted above, may be configured in a variety of ways. For instance, one sensor may be coupled to the primary transmitter 112 such that the sensor provides a sensor output indicative of the primary current in the primary transmitter 112. As another example, a sensor may be provided that is configured to provide a sensor output indicative of a primary capacitor voltage (e.g., a voltage of the capacitors CP in the illustrated embodiment of FIG. 5).

In one embodiment, a sensor may be configured to detect or provide a sensor output indicative of a characteristic of power with respect to any portion of the excitation system 10, including portions of the primary and/or secondary side. The controller 171 may control supply of power to the rotary transformer 100 based on one or more sensor outputs indicative of a characteristic of power with respect to one or more respective portions of the excitation system 10. As an example, a sensor may be configured to provide an output indicative of the current through the primary transmitter 112.

The controller 171 may be operable to control an operating characteristic, such as at least one of a frequency and a pulse width of the voltage supplied to the primary transmitter 112 (e.g., including a duty cycle and/or a phase shift angle of the voltage pulse applied to the primary transmitter 112), based on one or more sensor outputs. Additional to or alternative to frequency or pulse width, based on the one or more sensor outputs, the controller 171 may be configured to direct a change in an operating characteristic in the form of the DC output level of the DC power supply 170. Accordingly, the controller 171 may be operable to vary one or more operating characteristics of the excitation system 10 based on one or more sensor outputs.

Although, as noted above, the secondary side is rotating in the excitation system 10, the secondary side may include one or more sensors and communication circuitry operable to communicate sensor feedback to the primary side. Such communication circuitry may utilize the coupling between the primary transmitter 112 and the secondary receiver 152 (e.g., backscatter modulation) to transfer information to the primary side (e.g., the controller 171). Additionally, or alternatively, the communication circuitry may enable communication between the secondary side and the primary side separate from the coupling between the primary and secondary receivers. Such a separate communication system may utilize transmission circuitry for wirelessly communicating from the secondary side to the primary side in a manner that does not involve transmitting a signal via the secondary receiver 152 of the secondary side.

Additionally, or alternatively, the controller 171 may be operable to direct operation of the secondary side of the excitation system 10 via a communication with one or more aspects of the secondary side. For instance, the controller 171 may be configured to direct operation of the rectification circuitry 178 (e.g., active rectification circuitry) based on one or more sensor outputs. The secondary side of the excitation system 10 in this configuration may include a controller (not shown) configured to receive communications from the controller 171 and control the rectification circuitry 178 based on such communications. The controller of the secondary side of the excitation system 10 in this configuration may be operable to transmit communications to the controller 171, such as communications pertaining to one or more sensor outputs generated on the secondary side.

The secondary current in one embodiment may be substantially insensitive to changes in the field winding resistance of the field winding 180. The excitation system 10 may be configured to substantially maintain a constant field winding flux irrespective of changes in the field winding resistance, and as the field winding flux is directly proportional to the secondary current, the pulse width can be determined for a given field winding flux, such that the field flux can be maintained irrespective of changes in field winding resistance from temperature variation.

In one embodiment, the controller 171 and the inverter 172 may be configured to supply power in a polyphase manner to the rotary transformer 100, which is configured as a polyphase system. Examples of controller 171 and inverter 172 configurations for polyphase signals are described in U.S. Pat. No. 11,420,524 to Asa et al., entitled WIRELESS POWER SYSTEM, filed Dec. 18, 2020, issued Aug. 23, 2022—the disclosure of which is incorporated herein by reference in its entirety. The inverter 172 may include switching circuitry operable to output a drive signal for each of the coils of the primary transmitter 112, e.g., switching circuitry operable to drive a three-phase coupler configuration between the primary transmitter 112 and the secondary receiver 152. Likewise, the rectification circuitry 178 may be operable to condition signals received from the plurality of coils of the secondary receiver 152 for supply to the motor field winding or windings 180. In one configuration, the motor field windings 180 may correspond in number to the plurality of coils of the secondary receiver 152.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A three-phase rotary transformer comprising:
a stator that includes a primary three-phase coil and a primary ferromagnetic-material core;
a shaft configured to rotate relative to the stator during operation of the rotary transformer;
a holder including a pair of Al rings each affixed to the shaft and axially spaced from each other by a ring gap;
a rotor including:
a support connected to the shaft through the ring gap to rotate the rotor along with the shaft, and
a secondary three-phase coil disposed on the support and spaced apart from the primary three-phase coil by a predetermined gap.

2. The three-phase rotary transformer of claim 1, wherein the support includes a PCB.

3. The three-phase rotary transformer of claim 1, wherein the primary three-phase coil and the secondary three-phase coil each is implemented in either a unipolar three-phase coil or a bipolar three-phase coil.

4. A wound rotor synchronous motor comprising:
the three-phase rotary transformer of claim 1;
an inverter;
a resonant primary tuning network, wherein the primary three-phase coil is connected to the inverter through the resonant primary tuning network, such that currents through the primary three-phase coil create a time varying rotational magnetic field captured by the secondary three-phase coil, so the time varying rotational magnetic field causes a high frequency voltage induced on the secondary three-phase coil;
a rectifier; and
rotor windings connected to the secondary three-phase coil through the rectifier.

5. A rotary transformer comprising:
a stator that includes a primary coil and a primary ferromagnetic-material core;
a shaft configured to rotate relative to the stator during operation of the rotary transformer;
a holder including a pair of Al rings each affixed to the shaft and axially spaced from each other by a ring gap;
a rotor including:
a support connected to the shaft through the ring gap to rotate the rotor along with the shaft, and
a secondary coil disposed on the support and spaced apart from the primary by a predetermined gap,
wherein the Al rings are shaped and configured to reduce eddy currents induced therein during operation of the rotary transformer.

6. The rotary transformer of claim 5, wherein the Al rings are shaped and configured as rings with tapered edges.

7. The rotary transformer of claim 5, wherein the Al rings are shaped and configured as radially laminated rings.

8. The rotary transformer of claim 5, wherein the Al rings are shaped and configured as axially laminated rings.

9. The rotary transformer of claim 5, wherein the Al rings are shaped and configured as rings with periodic recessions on surfaces facing each other, the rings being angularly shifted by one-half pitch.

10. The rotary transformer of claim 5, wherein the Al rings are shaped and configured as sectored rings having a pitch size within a predetermined pitch-size range.

11. The rotary transformer of claim 10, wherein the sectored Al rings have tapered edges.

12. The rotary transformer of claim 5, wherein the primary coil and the secondary coil each is a single-phase coil.

13. The rotary transformer of claim 5, wherein the primary coil and the secondary coil each is a three-phase coil.

14. A wound rotor synchronous motor comprising:
the rotary transformer of claim 5;
an inverter;
a resonant primary tuning network, wherein the primary coil is connected to the inverter through the resonant primary tuning network, such that currents through the primary coil create a time varying rotational magnetic field captured by the secondary coil, so the time varying rotational magnetic field causes a high frequency voltage induced on the secondary coil;
a rectifier; and
rotor windings connected to the secondary coil through the rectifier.

15. An electric vehicle traction system comprising the wound rotor synchronous motor of claim 4.

16. A rotary transformer comprising:
a stator that includes a primary transmitter and a primary core;
a shaft configured to rotate relative to the stator during operation of the rotary transformer;
first and second of metal rings axially spaced from each other by a ring gap;
a rotor coupled to the shaft and operable to rotate along with the shaft, the rotor including:
a support disposed at least partially within the ring gap between the first and second metal rings, and
a secondary receiver coupled to the support and spaced apart from the primary by a predetermined gap, the secondary receiver configured to rotate with the rotor along with the shaft,
wherein the first and second metal rings are shaped and configured to reduce eddy currents induced therein during operation of the rotary transformer.

17. The rotary transformer of claim 16, wherein the support includes a PCB.

18. The rotary transformer of claim 16, wherein the primary transmitter includes a primary three-phase coil and the secondary receiver includes a secondary three-phase coil.

19. The rotary transformer of claim 18, wherein the primary three-phase coil and the secondary three-phase coil each is implemented in either a unipolar secondary three-phase coil or a bipolar secondary three-phase coil.

20. The rotary transformer of claim 16, wherein the primary transmitter and the secondary receiver are each single-phase coils.

21. A wound rotor synchronous motor comprising:
the rotary transformer of claim 16;
an inverter;
a resonant primary tuning network, wherein the primary transmitter is connected to the inverter through the resonant primary tuning network, such that currents through the primary transmitter create a time varying rotational magnetic field captured by the secondary receiver, so the time varying rotational magnetic field causes a high frequency voltage induced on the secondary receiver;
a rectifier; and
rotor windings connected to the secondary receiver through the rectifier.

22. The rotary transformer of claim 16, wherein the first metal ring includes a plurality of radially-laminated rings.

23. The rotary transformer of claim 16, wherein the first metal ring includes a plurality of axially-laminated rings.

24. The rotary transformer of claim 16, wherein the first and second metal rings each includes an inner surface and an outer surface spaced radially from the inner surface, wherein the first and second metal rings each includes an upper surface and a lower surface that oppose each other, wherein the ring gap is defined between the lower surface of the first metal ring and the upper surface of the second metal ring.

25. The rotary transformer of claim 24, wherein the lower surface of the first metal ring includes a first plurality of depressions, and the upper surface of the second metal ring includes a second plurality of depressions.

26. The rotary transformer of claim 25, wherein first and second metal rings are oriented relative to each about a common axis that is aligned with a central axis of the shaft, wherein the lower surface of the first metal ring is rotated with respect to the upper surface of the second metal ring so that each of the first plurality of depressions is rotated between first and second depressions of the second plurality of depressions.

27. The rotary transformer of claim 24, wherein the first and second metal rings are sectored such that each of the first and second metal rings includes one or more notches formed along their respective outer surfaces.

28. The rotary transformer of claim 27, wherein the one or more notches extend radially inward from the outer surface and are distributed at predetermined angular intervals about the circumference.

29. The rotary transformer of claim 28, wherein the one or more notches are rectangular, trapezoidal, or arcuate.

30. The rotary transformer of claim 24, wherein first and second rings each include an upper tapered surface between the outer surface and the upper surface and a lower tapered surface between the outer surface and the lower surface.

31. A rotary transformer comprising:
a stator that includes a primary transmitter and a primary core, the stator including a central axis, the primary transmitter including at least one primary side winding axis that is non-parallel to the central axis;
a shaft configured to rotate about the central axis relative to the stator during operation of the rotary transformer;
a rotor coupled to the shaft and operable to rotate along with the shaft, the rotor including a secondary receiver spaced apart from the primary by a predetermined gap, the secondary receiver configured to rotate with the rotor along with the shaft, the secondary receiver including at least one secondary side winding axis that is non-parallel to the central axis.

32. The rotary transformer of claim 31 wherein the primary transmitter is configured to transmit flux to the secondary transmitter in a radial direction relative to the central axis.

33. The rotary transformer of claim 31 wherein the primary transmitter includes a plurality of primary windings each having a primary side winding axis that is non-parallel to the central axis.

34. The rotary transformer of claim 33 wherein the plurality of windings are spaced evenly about the central axis.

35. The rotary transformer of claim 33 wherein the secondary receiver includes a plurality of secondary windings each having a secondary side winding axis that is non-parallel to the central axis.

36. The rotary transformer of claim 35 wherein, during operation, at at least one moment of time, the primary side winding axis of one of the primary windings is colinear with the secondary side winding axis of one of the secondary windings.

37. The rotary transformer of claim 31 wherein the primary transmitter and the secondary receiver each is implemented in either a unipolar three-phase coil or a bipolar three-phase coil.

38. A wound rotor synchronous motor comprising:
the rotary transformer of claim 31;
an inverter;
a resonant primary tuning network, wherein the primary transmitter is connected to the inverter through the resonant primary tuning network, such that currents through the primary transmitter create a time varying rotational magnetic field captured by the secondary receiver, so the time varying rotational magnetic field causes a high frequency voltage induced on the secondary receiver;
a rectifier; and
rotor windings connected to the secondary receiver through the rectifier.

39. An electric vehicle traction system comprising the wound rotor synchronous motor of claim 38.
